(19) United States
(12) Patent Application Publication
(10) Pub. No.: US 2016/0287468 A1
(43) Pub. Date: Oct. 6, 2016

(54) Aquatic Sexual Stimulation Assembly

(71) Applicant: GNARLY RIDE, INC., Las Vegas, NV (US)

(72) Inventor: Ronda Sue Montelli, Whittier, CA (US)

(73) Assignee: GNARLY RIDE, INC., Las Vegas, NV (US)

(21) Appl. No.: 14/937,674

(22) Filed: Nov. 10, 2015

Related U.S. Application Data
(60) Provisional application No. 62/141,017, filed on Mar. 31, 2015.

(51) Int. Cl. A61H 19/00; A61H 23/02

(52) U.S. Cl. CPC A61H 19/32; A61H 23/02

(57) ABSTRACT

An assembly or sexual stimulation in aquatic environments comprising a housing that accommodates a water-resistant sexual stimulation device with said housing attachable to or accommodated within an aquatic recreation or flotation device.

### FIELD OF THE INVENTION

The present invention relates to an aquatic sexual stimulation assembly. In one embodiment, the invention comprises an assembly attachable to an aquatic accessory or flotation device, such as an elongated noodle-type flotation device, to convert it into a floating apparatus for sexual stimulation.

### BACKGROUND OF THE INVENTION

Sexual stimulation devices or sex toys are objects generally used to facilitate sexual pleasure for one or multiple users. Vibrators are some of the most popular sex toys, which employ electrical energy to generate mechanical vibrations. These devices come in a variety of shapes and sizes, for both internal and external use. Some vibrators may be integrated into other objects such as dildos, condoms, and penile rings. Vibrators are used in many different settings, both indoors and outdoors. In particular, vibrators and other sexual stimulation devices may be used in aquatic settings; however, problems may arise regarding comfort, as users must worry about remaining afloat and in a desirable position while still pleasuring themselves or their partner(s). Additionally, electrical devices are often unsuitable for use in aquatic environments because they may malfunction or pose a safety hazard.

Nevertheless, the use of sexual stimulation devices in aquatic environments, particularly while floating, can promote enhanced sexual experiences. Reports have suggested that flotation increases the secretion of neurochemicals associated with pleasure or well-being, thereby heightening sensations obtained via sexual stimulation while afloat. Reports have also indicated that floating increases production of theta waves, which are associated with vivid memories, free association, sudden insights, creative inspiration, and feelings of serenity and oneness with the universe. Aquatic environments are thus well-suited to the appropriate use of sexual stimulation devices to produce enhanced pleasure in comparison to terrestrial environments.

It is therefore an objective of the present invention to introduce an assembly that converts a standard personal flotation device into an aquatic sexual stimulation device. One embodiment of the present invention comprises an assembly that retrofits an aquatic elongated pool noodle-type flotation device. More specifically, a saddle assembly that attaches to the noodle and contains or is configured for use with a vibrator or other sexual stimulation device. Users can straddle the noodle, positioning parts of their body on or near the saddle assembly to interact with the sexual stimulation device, A plurality of buttons or other control mechanisms may be used to turn the device on and off and to adjust the speed and intensity of vibration.

More generally, other flotation devices commonly used for aquatic recreation, relaxation, or fitness can retrofitted, designed, or adapted to accommodate a water-resistant sexual stimulation device of the sort more commonly associated with terrestrial environments. While pool noodles are a common accessory for pools and other aquatic environments, other positive buoyancy aquatic accessories such as pool rafts, inner tubes, or inflatable objects can be retrofitted, designed, or adapted to accommodate a sexual stimulation device according to the present invention.

### BRIEF DESCRIPTION OF THE DRAWINGS

FIG. 1 is a perspective view of a saddle form of the assembly adapted for use with a pool noodle. This view displays a perspective view of the assembly attached to a pool noodle;

FIG. 2 is a side view of a saddle form of the assembly;

FIG. 3 is a top down view of a saddle form of the assembly with a vibrating device that can be used therewith;

FIG. 4 is a top down view of a saddle form of the assembly with a vibrating device that can be used therewith.

### DETAILED DESCRIPTION

Certain aspects, advantages, and novel features of various embodiments are described herein. It is to be understood that not necessarily all such advantages may be achieved in accordance with any particular embodiment. Thus, for example, those skilled in the art will recognize that embodiments may be effectuated and/or carried out in a manner that achieves one advantage or group of advantages as taught herein without necessarily achieving other advantages as may be taught or suggested herein. All illustrations of the drawings are for the purpose of describing selected versions of the present invention and are not intended to limit the scope of the present invention.

In view of the aforementioned problems and needs, the present invention comprises an aquatic accessory adapted for use with or containing a sexual stimulation device, where the accessory is adapted for use with one or more common recreational pool items, such as pool noodles, inner tube, or inflatable figures to create a floating sexual-stimulation apparatus.

It is to be understood that the invention is not limited in its application to the details of the components and arrangements as described or illustrated. The invention is capable of other embodiments and of being utilized and carried out in various ways. It is also to be understood that the phrasing and terminology employed herein are for the purpose of description and should not be regarded as limiting.

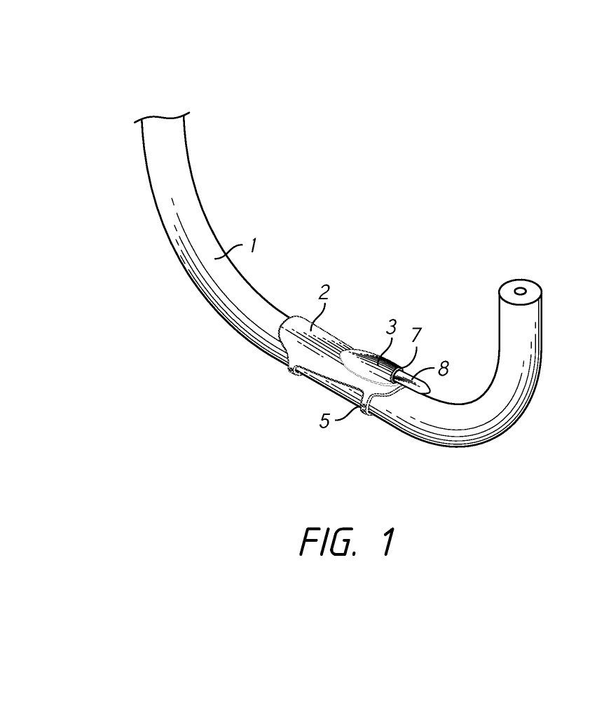

In the preferred embodiment of the present. invention depicted in FIGS. 1-4, the assembly comprises a saddle assembly with a removable water-proof vibrating element where the contour and straps of the assembly are adapted for use with a noodle-type aquatic recreation device. The saddle assembly comprises a plurality of buttons, a housing that accommodates or seats a sexual stimulation device, and one or more straps and fasteners. In the preferred embodiment, the saddle is attachable to an aquatic elongated. noodle-type flotation device. The noodle is a long soft, deformable, tubular shaped object made of a material with positive buoyancy, such as polyethylene foam, commonly used as an aquatic recreation or flotation device. The noodle may have one or more cross sectional shapes and it may be uniform or non-uniform throughout its length; however, for the purpose of simplicity, the noodle will herein have a circular cross sectional shape that is uniform throughout its entire length. The noodle may or may not contain a hollow core that extends between its two ends.

Referring now to FIG. 1, illustrated therein is the assembly in saddle form 2 attached to a pool noodle 1. The assembly contains a housing 3 in which a sexual stimulation device 8 may be permanently or removably seated 7. The assembly 2 is fastenable to the pool noodle 1 via straps with eyelets 5.

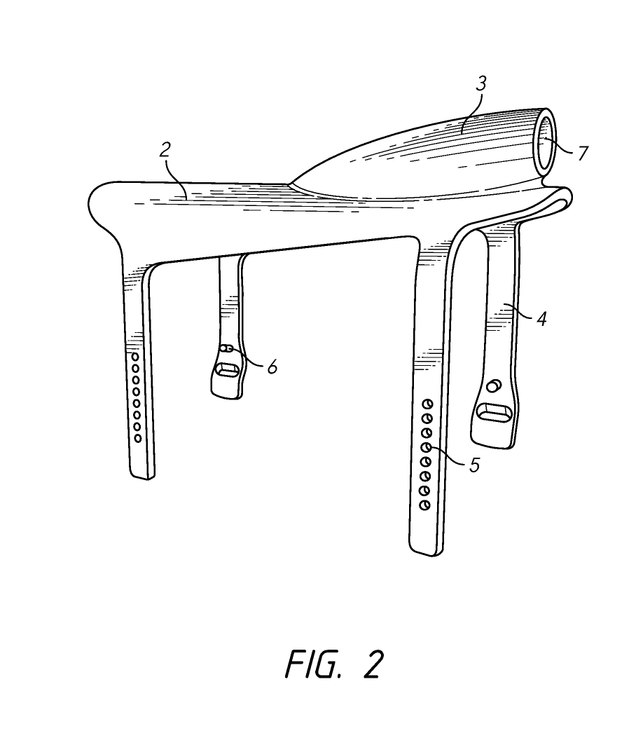

Referring now to FIG. 2, illustrated therein is a side view of the assembly 2 in saddle form. The housing 3 contains an opening in which a sexual stimulation device may be permanently or removably seated. The specific design of the housing 3 will be a function of the dimensions and type of sexual stimulation device. In this embodiment of FIG. 2, the assembly has four straps 4 that can be secured. around the noodle via buckles 6 that engage with eyelets 5. Other approaches to securing the assembly to an aquatic. recreation or flotation device would be apparent to one having skill in the art based on the particular properties of the aquatic recreation or flotation device.

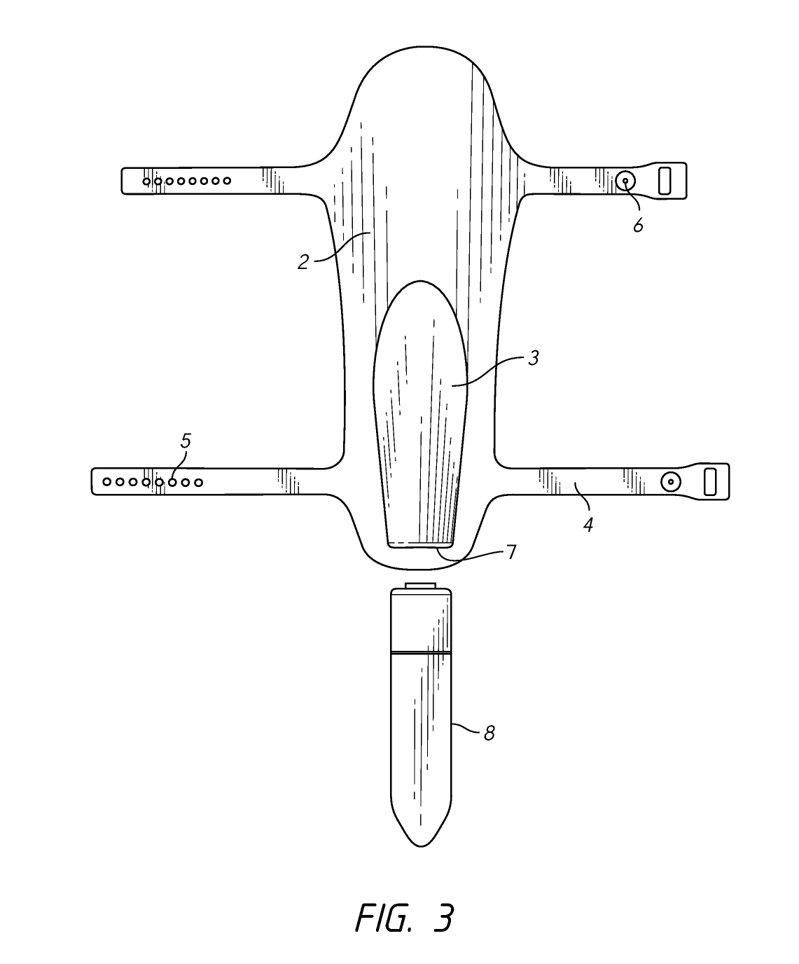

Referring now to FIG. 3, illustrated therein is a top down view of the assembly 2 in saddle form with the sexual stimulation device 8 unseated from the housing 3.

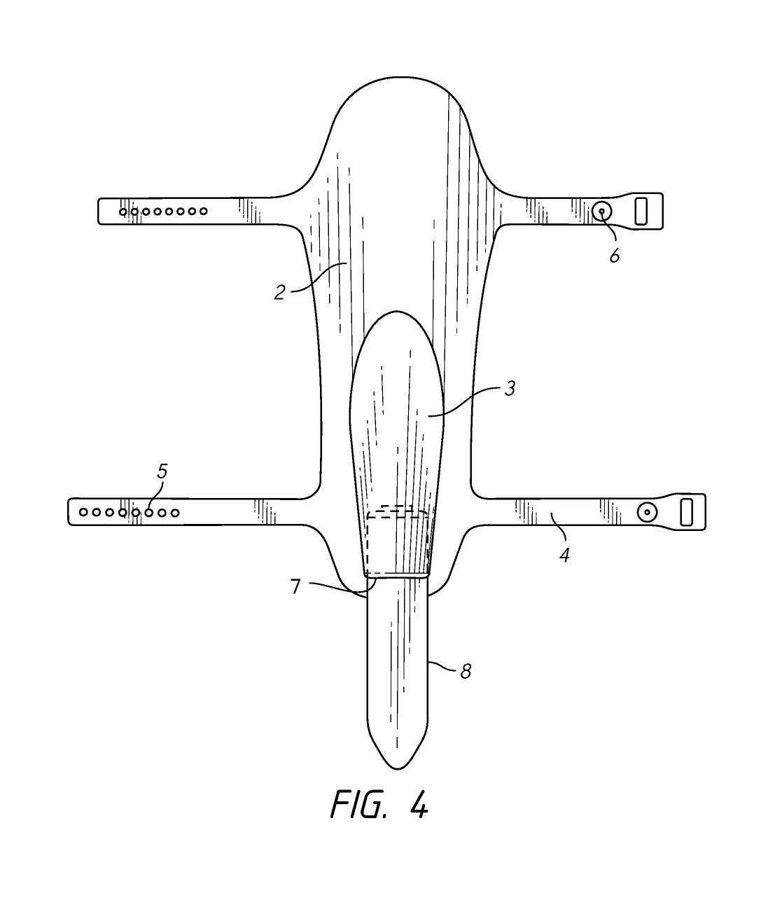

Referring now to FIG. 4, illustrated therein is a top down view of the assembly 2 in saddle form with the sexual stimulation device 8 seated within the housing 3.

In the preferred embodiment, the main body of the saddle is relatively soft, flexible, and waterproof, and is made from silicone rubber or a rubber-like polymer with similar characteristics. The material should be rigid enough so that it can be securely attached to the noodle, via straps or other means, and retain the sexual stimulation device such that it is not dislodged in standard use.

The main body of the saddle embodiment comprises two sides that are parametrically joined at their edges via two sets of adjustable straps that can be fastened around the noodle or other aquatic device. In the central portion of the saddle is a cavity in which the preferred sexual stimulation device can be seated or enclosed. The saddle can be sold with a waterproof vibrator, such as a bullet vibrator, of appropriate dimensions so that can be seated and unseated from the saddle. Alternatively, the vibrator or sexual stimulation device can be permanently affixed to or within the saddle enclosure. In a further embodiment, the aquatic accessory can be manufactured with the saddle or vibrator housing permanently affixed.

When seated on the saddle, one end of the sexual stimulation device is accommodated within a housing attached to the main body, with the rest of the sexual stimulation device protruding from the main body of the assembly. The sexual stimulation device may be a variety of shapes. For safe and effective use, the sexual stimulation device needs to be substantially waterproof or enclosed within a waterproof cavity. If powered, the sexual stimulation device will typically be powered. by a battery, which may be rechargeable. The user may manually adjust the setting of the sexual stimulation device via the device itself or via an interface on the assembly to effect such adjustments. In the latter case, the buttons may be located on the main body of the assembly, while their top protruding outwards. One of the plurality of buttons functions as an on/off switch for the vibrating device with others controlling the speed and intensity.

In the preferred embodiment, the proximal ends of the straps are fixed to the sides of the saddle's main body. The straps are thin flat pieces of flexible, sturdy, waterproof material, such as silicone rubber, and may be of similar constitution as the saddle itself. A portion of the fastener, which may be a hook-and-loop fastener (e.g., Velcro®) or other fastener, such as a detachable rivet, is located on one side of the strap, at an end opposite the fixed end. Another portion of the fastener that engages with the aforementioned. portion on the strap is located on the side of the straddle's main body with the vibrating device, by an edge opposite from the strap's fixed end. To retrofit the saddle to a noodle, the side of the saddle's main body with the housing for the sexual stimulation device will face away from the noodle's exterior lateral surface. With this, the main body of the saddle will fit around part of the noodle, contouring to its exterior shape. The straps will then be fastened around the noodle until both portions of the fastener engage with one other, preventing the saddle from sliding off the aquatic recreation or flotation device. When connected to a noodle, the saddle will generally be positioned approximately equidistant from the noodle's two ends however, this may vary.

In alternative embodiments of the present invention, one or more of the plurality of buttons may be used to actuate a heating element disposed within the vibrating device. The assembly may also be adapted to house two or more sexual stimulation devices or to attach to an aquatic recreation or flotation device in a different manner. The assembly could also be molded to or within the aquatic recreation or flotation device during manufacture. These changes may occur as long as the scope and objective of the present invention remains unchanged.

In alternative embodiments of the present invention, a single upper and lower strap will wrap around the entire assembly and fasten to themselves or a portion of the assembly proximal to their origin. As well, a D-ring or similar object may be attached to the edge of the saddle, away from the strap's fixed end. The D-ring will be shaped and dimensioned to receive the strap, allowing the strap to be folded back over itself as a means of tightening and securing the saddle to the noodle. In alternative embodiments of the present invention, the hook and loop fastener will be replaced with an adjustable buckle or similar securing device. A variety of other techniques for securing the saddle to the noodle or other aquatic accessory will be apparent to one of ordinary skill in the art.

In another embodiment of the invention, a handle bar assembly may also be retrofit to the noodle or aquatic accessory. The headpiece is generally a cylindrical piece, however, this may vary. The head piece comprises two ends that are perpendicularly and parametrically joined by a lateral surface. A cavity begins at one end of the head piece and extends towards the other end, parallel to the lateral surface. The cavity is shaped and dimensioned to snuggly receive an end of the noodle with a relatively tight tolerance. Thus, the handle bar assembly attaches to the noodle with a snug press fit, with the head piece fitting directly over and around an end of the noodle. This snug press fit will prevent the head piece from accidently slipping off the noodle. Each of the pair of arms is fixed at an end to the head piece. The pair of arms extends outwards and away from the head piece's lateral surface. The pair of arms may be rigid or somewhat flexible. If the pair of arms is rigid, one or both of their shapes may be straight bent. Each of the pair of handles is attached to one of the corresponding pair of arms, at the end that is not fixed to the head piece. The pair of handles is generally rigid but may also be soft. With the saddle and handle bar assembly mounted to the noodle, users will generally straddle the noodle and face towards the handle bar assembly. The pair of handles functions as grips that assist users with balancing when they are straddling the saddle and noodle. Users may also grab or hold onto the pair of arms to maintain their balance.

In alternative embodiments of the present invention, other toys, rings, holders, and gadgets may be fixed or removably attached to the saddle. These changes and additions may occur as long as the scope and objective of the present invention remains unchanged.

Although the invention has been explained in relation to its preferred embodiment, it is to be understood that many other possible modifications and variations can be made without departing from the spirit of the scope of the invention.

What is claimed is:

1. An assembly with a housing that accommodates a water-resistant sexual stimulation device;
wherein said assembly is attachable to an aquatic recreation or flotation device; and
whereby said sexual stimulation device is useable in conjunction with said aquatic recreation or flotation device in an aquatic environment.

2. The assembly of claim 1, wherein said housing for the sexual stimulation device contains an orifice such. that the sexual stimulation device can be seated in and removed from said housing.

3. The assembly of claim 1, wherein said assembly is in the form of a saddle.

4. The assembly of claim 1, wherein said assembly is made of silicon rubber.

5. The assembly of claim 1, wherein said assembly is attachable to the aquatic recreation or flotation device via one or more straps.

6. The assembly of claim 1, wherein said assembly is attachable to the aquatic recreation or flotation device via a strip comprised of hook and loop fasteners. The assembly of claim 2, wherein said assembly is in the general form of a saddle.

8. The assembly of claim 2, wherein said assembly is made of silicon rubber.

9. The assembly of claim 2, wherein said assembly is attachable to the aquatic recreation or flotation device via one or more straps.

10. The assembly of claim 2, wherein said assembly is attachable to the aquatic recreation or flotation device via a strip comprised of hook and loop fasteners.

11. The assembly of claim 7, wherein the housing is elevated above the base of the saddle.

12. The assembly of claim 9, wherein said straps are fastenable via eyelets in said straps.

13. An assembly with a housing to accommodate a water-resistant sexual stimulation device;
wherein said assembly is incorporated within a positive buoyancy aquatic recreation or flotation device; and
whereby said sexual stimulation device can be utilized in conjunction with said aquatic recreation or flotation device in an aquatic environment.

14. The assembly of claim 13, wherein said housing for the sexual stimulation device contains a sealable chamber where said sexual stimulation device is retained.
